(19) United States
(12) Patent Application Publication
(10) Pub. No.: US 2004/0118674 A1
(43) Pub. Date: Jun. 24, 2004

(54) Air cleaning method and apparatus

(76) Inventor: Yong Hak Lee, Fullerton, CA (US)

Correspondence Address: JONATHAN Y. KANG, ESQ., LEE & HONG P.C., 14th Floor, 801 S. Figueroa Street, Los Angeles, CA, 90017, US

(21) Appl. No.: 10/422,491

(22) Filed: Apr. 24, 2003

(30) Foreign Application Priority Data
Dec. 18, 2002 (KR) 20-2002-37714

(51) Int. Cl. B01J 19/08; B01J 19/12

(52) U.S. Cl. 204/164; 422/186.04

(57) ABSTRACT

There is provided an air cleaner which includes an air inlet, a first electromagnetic wave shield disposed adjacent to the air inlet, an electrical means for air induction, a second electromagnetic wave shield disposed adjacent to the air outlet, and a grounding means. The electrical means for air induction draws in air through the first electromagnetic wave shield and exhausts it towards the air outlet and through the second electromagnetic the wave shield. The grounding means discharges current induced in the first and second electromagnetic wave shields. There is also provided a method describing the operation of an embodiment of the air cleaner.

### CROSS REFERENCE TO RELATED APPLICATIONS

Pursuant to 35 U.S.C. § 119(a), this application claims the benefit of earlier filing date and right of priority to the Korean Application No. 20-2002-37714, filed on Dec. 18, 2002, the content of which is hereby incorporated by reference herein in its entirety.

### FIELD OF THE INVENTION

The present invention relates generally to an air cleaner and, more particularly, to an air cleaner having a grounding function.

### BACKGROUND OF THE INVENTION

There has been a necessity for countering electromagnetic waves produced by home appliances. It is well known in the art that electromagnetic waves and resulting fields can pose a health hazard to human beings and may cause disruption at the cellular levels. Electromagnetic waves, hereinafter also referred to as electric field noise, are emitted by a driving current during operation of electrical home appliances. Electrical home appliances, such as televisions, stereo equipment, and electrical beds and mats, emit quantifiable amounts of electromagnetic waves. Due to the risks of exposure to electromagnetic waves, measures for countering electric field noise should be required for most, if not all, home appliances installed in the living space. The most common countering measure is to ground the circuits of the electrical home appliance, thereby shielding against electromagnetic waves. By grounding such appliances, leakage currents generated by the appliances are bypassed to ground, further preventing accidental electric shocks.

Inventions designed to discharge electromagnetic waves by using a grounding potential are well known. For example, Korean Utility Model Registration No. 239143 discloses a carbon polymer heater for mats, which is designed to attenuate electromagnetic waves by facing primary and secondary windings. In Korean Utility Model Registration No. 251672, a thermostat heater is described and includes an inner winding heater, a nylon thermister, a winding under a nylon layer, a winding on a nylon layer, and an outer winding to discharge electromagnetic waves emitted from the heater to an external electric field. Another example is disclosed in Korean Patent No. 341280, which teaches an apparatus for shielding electromagnetic waves of thermo-electric mats by including a spiral inner lead wire and a spiral outer lead wire which are connected to one common ground.

Further examples include Korean Utility Model Registration No. 255095, which describes a temperature-sensitive heater formed in a structure of three layers of windings. The structure includes an exothermic winding, a current supply winding connected to one side of a nylon thermister, and a temperature detection winding connected to the other side of the thermister. This configuration results in providing electromagnetic waves to a neutral electric field of an alternating current (AC). Similarly, in Korean Patent Application No. 2002-0019148, an automatic grounding switching circuit, that is designed to allow grounding using a neutral potential in both the one-line grounding mode and the neutral grounding mode of an AC power source, is provided. With respect to the aforementioned inventions described above and in the previous paragraph, parts emitting electromagnetic waves are covered with organic materials for shielding purposes and are connected to grounding means to discharge the electromagnetic waves.

In FIG. 1, the common home appliance of a conventional air cleaner is shown. The conventional air cleaner 100 includes a suction chamber 110, an intermediate chamber 120, and a filtering chamber 130. An air blower 112 is disposed in the suction chamber 110. In operating the air cleaner 100, external air is filtered while flowing into the intermediate chamber 120 through a first filter 111 and then through an air inlet 121. The air flow is aided by the suction created by the air blower 112. From the intermediate chamber 120, the air then passes through an air outlet 131 and into the filtering chamber 130. The air is subsequently filtered through second and third filters 132 and 133 and emitted to an external space through a grill 134.

Generally, the first filter 111 is a sponge filter, the second filter 132 is a paper filter, and the third filter 133 is a copper filter. In such air cleaners as shown in FIG. 1, the cabinet housing the air cleaner 100 shields some of the electromagnetic waves. However, some the electric field noise is also discharged in the external space from the air blower 112 via the air inlet 121, the air outlet 131, and the grill 134. In conventional cylindrically shaped air cleaners, shown in FIGS. 2 and 3, an air blower 210 and a ring-shaped filtering chamber 217 are formed in an air cleaner 200. External air is filtered while flowing into an air blower 210 through first, second and third filters 211, 212 and 213. The filtered air then passes through an inlet 214 and is discharged into external space through an air outlet 215 and a grill 216. Similar to the air cleaner of FIG. 1, electromagnetic waves generated by the operation of the air blower 210 in FIGS. 2 and 3 are discharged into the external space through the air outlet 215.

FIG. 4 shows a conventional grounding circuit diagram of a home appliance. In FIG. 4, a grounding selection circuit 300 receives an AC voltage H of 220 volts (V) and of a frequency of 60 Hz. The current H is supplied to an electromagnetic device M, such as the motor of a home appliance, for operation. An ozone discharge tube 600 and negatively charged ion tip 700, commonly provided in electrical home appliances, supply direct current through a rectifier 400 and an ignition timer 500 for a preset time. A grounding connection GC of the home appliance is connected to the grounding component of the ground selection circuit 300, that is, a neutral potential point N or a ground G.

As shown by FIGS. 1-4, there is a need to further enhance the shielding effects of common home appliances such as air cleaners from electric field noise.

### SUMMARY OF THE INVENTION

Accordingly, the present invention is directed to an improved air cleaning method and apparatus that substantially obviates one or more problems due to the limitations and disadvantages of the related art. It is, therefore, an object of the present invention to provide an air cleaning method and apparatus that effectively shields electromagnetic waves discharged from the air cleaner and discharges current induced in electromagnetic wave shields to a ground or grounding component.

In order to achieve the aforementioned object of the present invention, there is provided an air cleaner which comprises an air inlet, a first electromagnetic wave shield disposed adjacent to the air inlet, an electrical means for air induction, a second electromagnetic wave shield disposed adjacent to the air outlet, and a grounding means. The electrical means for air induction draws in air through the first electromagnetic wave shield and exhausts it towards the air outlet and through the second electromagnetic the wave shield. The grounding means discharges current induced in the first and second electromagnetic wave shields.

According to one aspect of the present invention, the first and second electromagnetic wave shields comprise (10) copper mesh. The air cleaner also may comprise a cabinet made of electromagnetic wave shielding material to house the air cleaner. Further, the air cleaner may comprise an ozone discharge tube and/or a negatively charged ion tip.

According to another aspect of the present invention, the grounding means may be a grounding component of a ground selection circuit connected to a power source providing an alternating current. Alternatively, the grounding means may be a ground connected to an electrical outlet supplying a current via a plug.

In another embodiment of the present invention, the air cleaner may have a cylindrical shape.

There is also provided a method of air cleaning, which comprises the following steps: (1) operating an electrical air inducing means to draw in air; (2) discharging leakage current generated by the operation of the air inducing means to ground; (3) drawing in air through an air inlet, wherein the air passes through a first electromagnetic wave shield; (4) shielding the air inlet from electromagnetic waves, which are created by the operation of the electrical air inducing means, with the first electromagnetic wave shield; (4) discharging electrical current generated in the first electromagnetic wave shield by electromagnetic waves from the electrical air inducing means to ground; (5) exhausting air through an air outlet, wherein air passes through a second electromagnetic wave shield; (6) filtering air through one or more filters; (7) shielding the air outlet from electromagnetic waves, which are created by the operation of the electrical air inducing means, with the second electromagnetic wave shield; (8) discharging electrical current generated in the second electromagnetic wave shield by electromagnetic waves from the electrical air inducing means to ground; and (9) exhausting filtered air to an external space.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. Therefore, it is to be understood that both the foregoing general description and the following detailed description are exemplary and explanatory and are intended to provide a further explanation of the invention as claimed.

### BRIEF DESCRIPTION OF THE DRAWINGS

The accompanying drawings, which are included to provide a further understanding of the invention and are incorporated in and constitute part of this specification, illustrate embodiments of the invention and, together with the description, serve to explain the principles of the invention.

FIG. 1 is a sectional view of a conventional air cleaner;

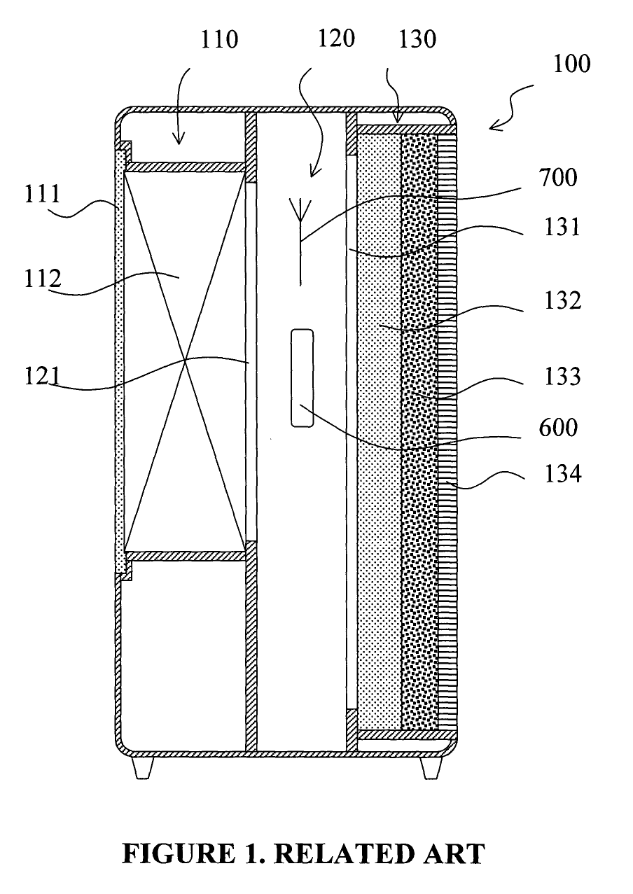

FIG. 2 is a perspective view of a conventional cylindrically shaped air cleaner;

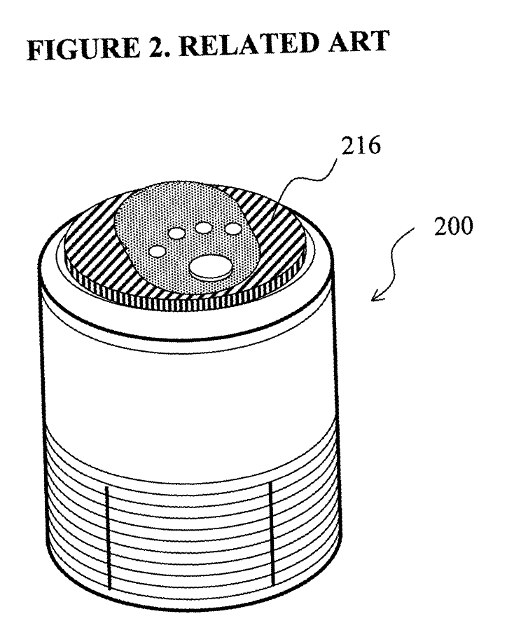

FIG. 3 is a sectional view of the conventional cylindrically shaped air cleaner of FIG. 2;

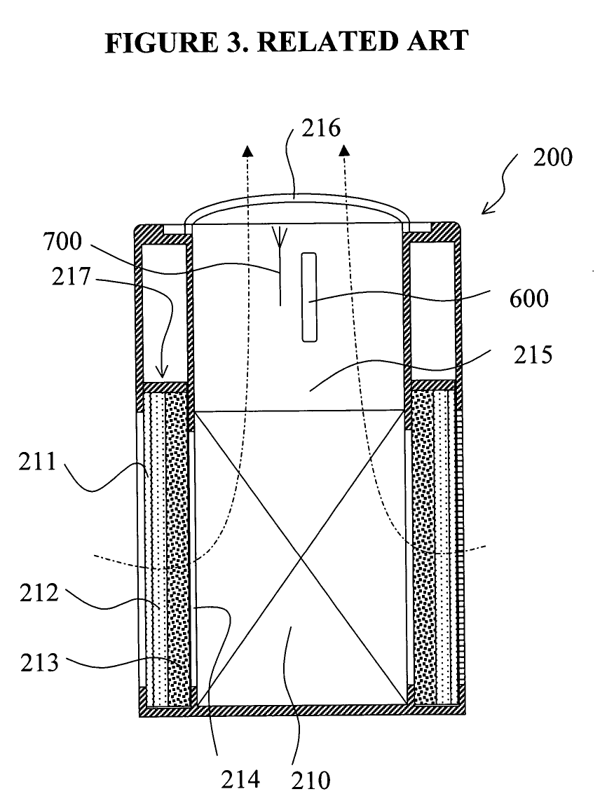

FIG. 4 is a conventional grounding circuit diagram of a conventional electrical home appliance;

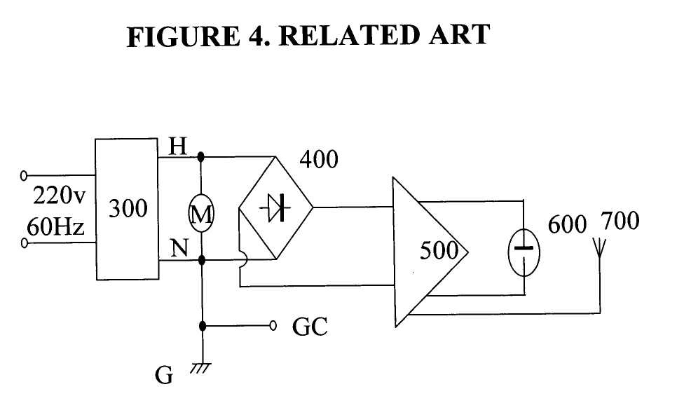

FIG. 5 is a sectional view of an air cleaner including electromagnetic wave shields in accordance with an embodiment of the present invention;

FIGS. 6A and 6B are plan views of the electromagnetic wave shields of the air cleaner shown in FIG. 5, in accordance with an embodiment of the present invention;

FIG. 7 is a sectional view of a cylindrically shaped air cleaner including electromagnetic wave shields in accordance with another embodiment of the present invention;

FIGS. 8A and 8B are plan views of the electromagnetic wave shields of the air cleaner shown in FIG. 7, in accordance with an embodiment of the present invention;

FIG. 9 is a grounding circuit diagram of an air cleaner in accordance with an embodiment of the present invention;

FIG. 10 is a grounding circuit diagram of an air cleaner in accordance with another embodiment of the present invention; and

FIG. 11 is a grounding circuit diagram of an air cleaner in accordance with another embodiment of the present invention.

### DETAILED DESCRIPTION OF THE PREFERRED EMBODIMENTS

Hereinafter, the present invention will be described with respect to the preferred embodiment illustrated in the annexed drawings.

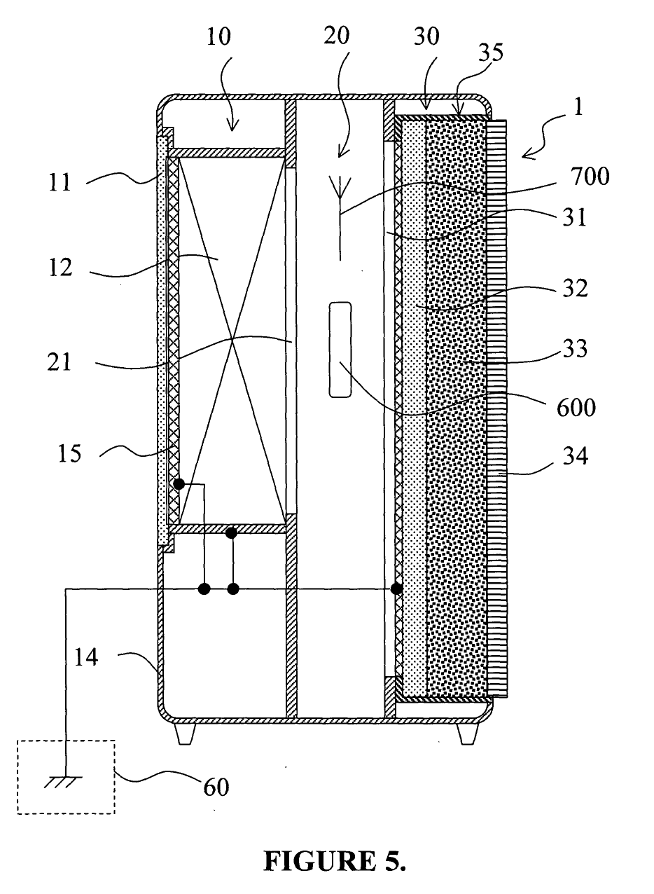

FIG. 5 is a sectional view of an air cleaner 1 including electromagnetic wave shields in accordance with an embodiment of the present invention. As shown in FIG. 5, the air cleaner 1 includes a suction chamber 10, an intermediate chamber 20, and a filtering chamber 30. An air blower 12 is disposed in the suction chamber 10. In operating the air cleaner 1, external air is filtered while flowing into the intermediate chamber 20 through a first filter 11 and then through an air inlet 21. The air flow is aided by the suction created by the air blower 12. From the intermediate chamber 20, the air then passes through an air outlet 31 and into the filtering chamber 30. The air is subsequently filtered through second and third filters 32 and 33 and emitted to an external space through a grill 34.

Also shown in FIG. 5, a cabinet housing the air cleaner 1 is made of electromagnetic wave shielding material. A first electromagnetic wave shield 15 is disposed at the air inlet 21. A second electromagnetic wave shield 35 is disposed in the filtering chamber 30 at the air outlet 31, wherein the wave shield 35 preferably surrounds the inner surfaces of the top, bottom and side adjacent to the air outlet 31 of the filtering chamber 30. The first and second electromagnetic wave shields 15 and 35, as well as the air blower 12, are connected to a ground 60. An ozone discharge tube 600, for removing odors, and a negatively charged ion tip 700, for air purification, are arranged in the intermediate chamber 20.

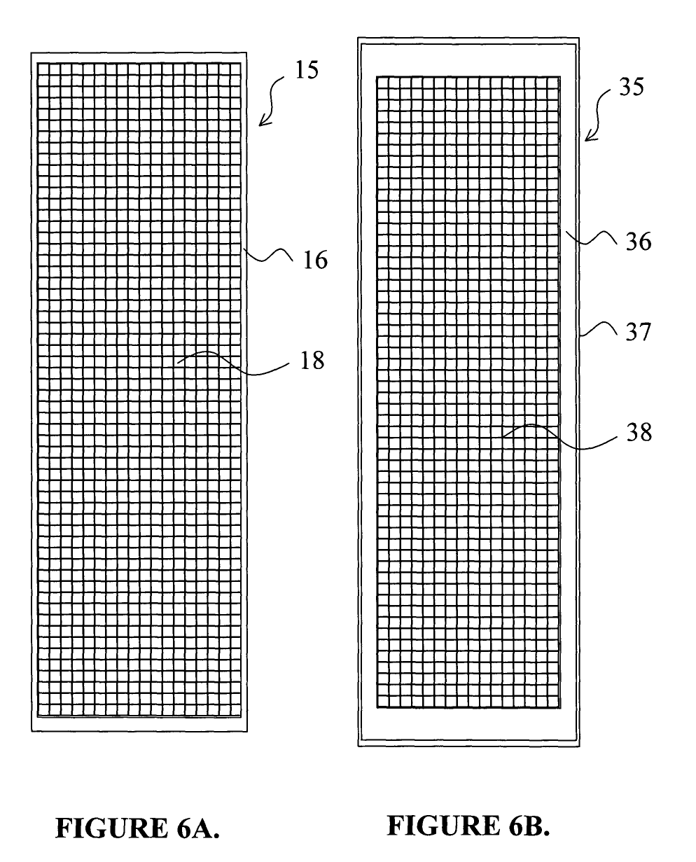

FIGS. 6A and 6B illustrate the structure of the electromagnetic wave shields 15 and 35 disposed in the air cleaner 1 as shown in FIG. 5. The wave shields 15 and 35 are formed of electricity conduction nets and are formed of a (10) mesh copper net 18 and 38, respectively. The wave shield 15 in FIG. 6A, which is surrounded by a frame 16, is preferably inserted between the first filter 11 and the air blower 12 to shield electromagnetic waves flowing into the air inlet 21 formed behind the air blower 12. The wave shield 35 in FIG. 6B contains space 36 for disposing the second and third filters 32 and 33 therein. Preferably, a frame 37 is attached around the (10) mesh copper net 38.

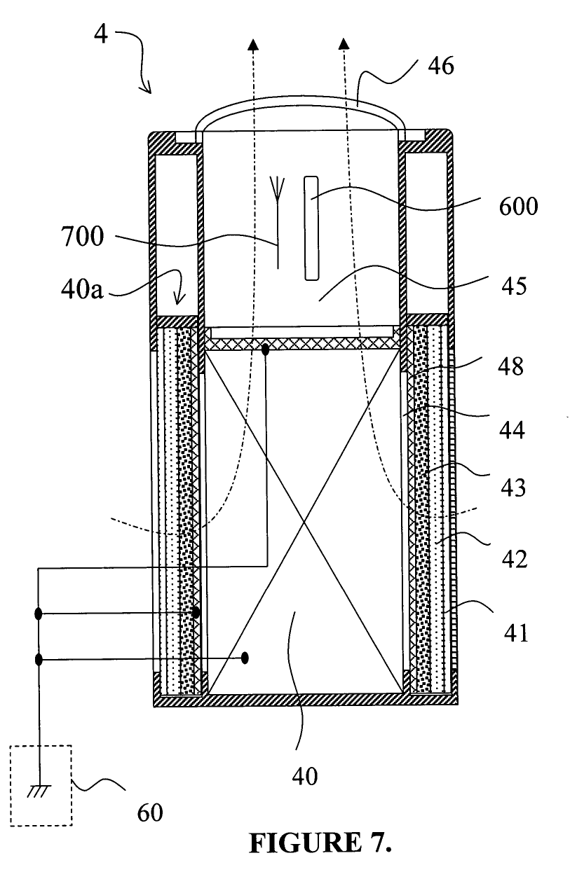

FIG. 7 is a sectional view of a cylindrically shaped air cleaner including electromagnetic wave shields in accordance with another embodiment of the present invention. As shown in FIG. 7, an air blower 40 and a ring shaped filtering chamber 40a are disposed in an air cleaner 4. External air is filtered while flowing into an air blower 40 through first, second and third filters 41, 42 and 43. The filtered air then passes through an inlet 44 and is discharged into external space through an air outlet 45 and a grill 46. An ozone discharge tube 600, for removing odors, and a negatively charged ion tip 700, for air purification, are arranged in the air outlet 45.

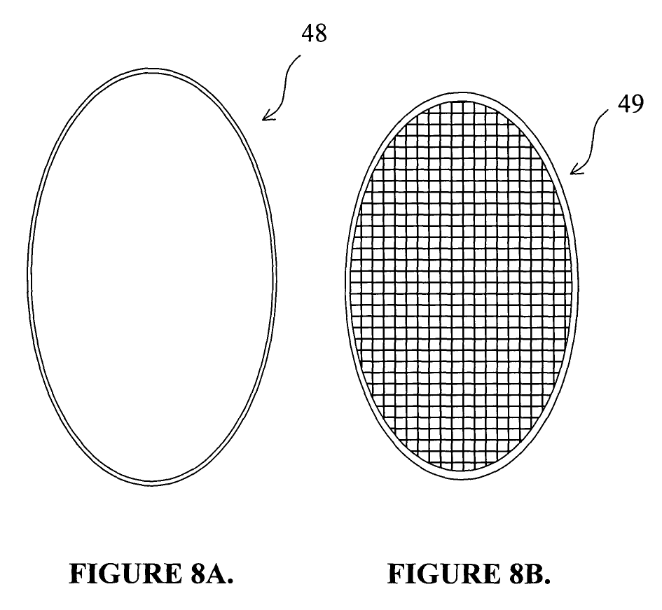

In this embodiment of the present invention, electromagnetic wave shields 48 and 49 are preferably arranged along the inner circumference of the ring shaped filtering chamber 40a and underneath the air outlet 45, respectively. This arrangement provides for shielding electromagnetic waves generated by the air blower 40. In FIG. 8A, the electromagnetic wave shield 48, which has a ring shape to comport with the filtering chamber 40a, is also latticed when viewed from the side in order to effectively discharge electromagnetic waves. FIG. 8B illustrates the wave shield 49, which is disposed at the air outlet 45, retains a circular shape.

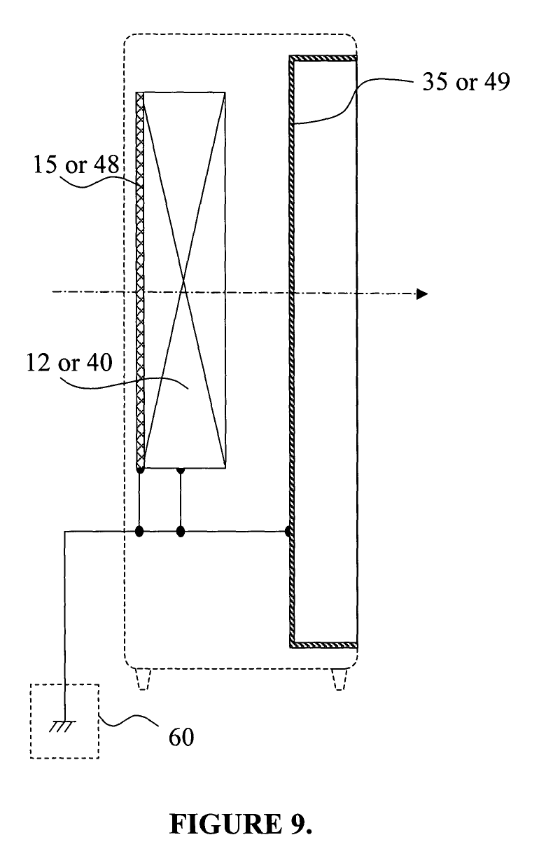

FIGS. 9, 10 and 11 are grounding circuit diagrams of air cleaners in accordance with embodiments of the present invention. In FIGS. 9, 10 and 11, the shapes of the electromagnetic wave shields are illustrated on the basis of the embodiment described in FIG. 5. However, these circuit diagrams can also be applied to the embodiment shown in FIG. 7 (as well as other embodiments); therefore, FIGS. 9, 10 and 11 will described with respect to both embodiments.

As shown in FIG. 9, the electromagnetic wave shield 15 or 48 is disposed at the air inlet side (as indicated by the arrow denoting air flow direction) adjacent to the air blower 12 or 40. The electromagnetic wave shield 35 or 49 is disposed at the air outlet side and is connected to the ground 60. Any leakage current generated by the air blower 12 or 40 is discharged to the ground 60 in order to prevent electric shock. Additionally, prior to the discharge of electromagnetic waves through the air inlet side 21 or 44, electromagnetic waves discharged from the air blower 12 or 40 induce current in the electromagnetic wave shield 15 or 48. Subsequently, the induced current is discharged to the ground 60. Similarly, before the electromagnetic waves are discharged through the air outlet side 31 or 45, electromagnetic waves induce current in the electromagnetic wave shield 38 or 49. The induced current is then discharged to the ground 60. Consequently, the amount of electric field noise present in the external space is reduced.

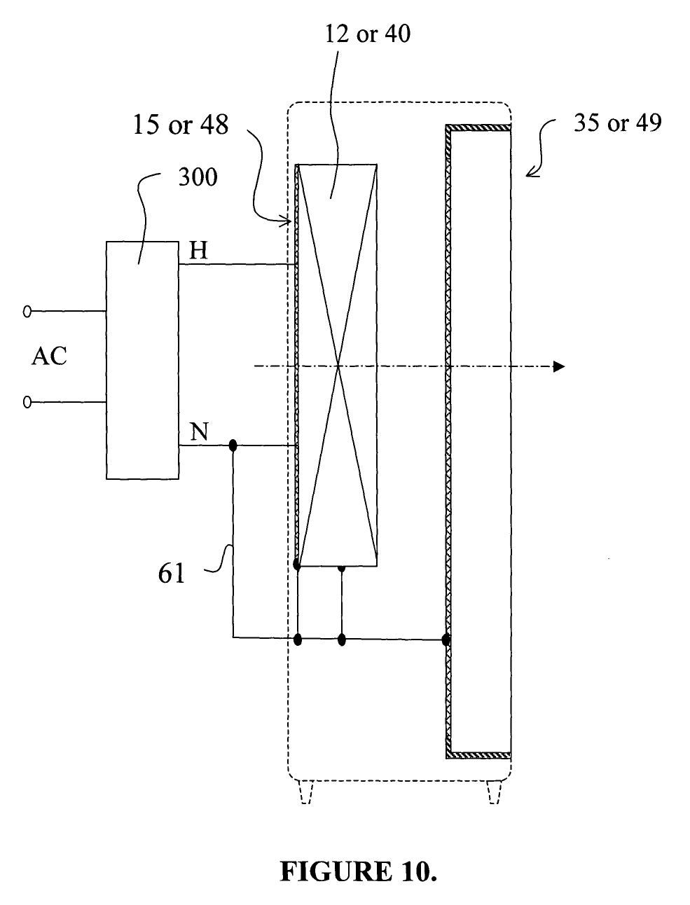

In FIG. 10, a ground selection circuit 300, which provides a grounding means, receives AC voltage H to the air blower 12 or 40 in order for operation. Should the air blower 12 or 40 generate leakage current, the current will be discharged to a grounding component, such as a neutral potential point N, through a discharge line 61 in order to prevent electric shock. Additionally, prior to the discharge of electromagnetic waves through the air inlet side 21 or 44, electromagnetic waves discharged from the air blower 12 or 40 induce current in the electromagnetic wave shield 15 or 48. Subsequently, the induced current is discharged to the neutral potential point N. Similarly, before the electromagnetic waves are discharged through the air outlet side 31 or 45, electromagnetic waves induce current in the electromagnetic wave shield 38 or 49. The induced current is then discharged to the neutral potential point N. As a result, the total amount of electromagnetic waves discharged to the external space is diminished.

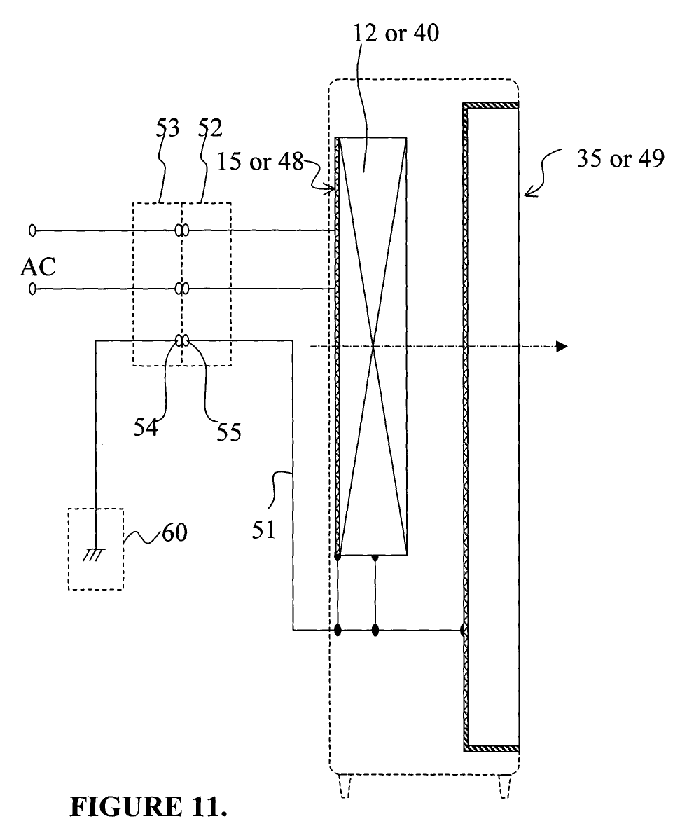

FIG. 11 shows a commercial AC current being supplied to the air blower 12 or 40 through a conventional wall electrical outlet 53 and a plug 52. The air blower 12 or 40 is electrically connected to the ground 60. The ground 60 is connected to contact terminals 54 and 55 of the electrical outlet 53 and plug 52 via a discharge line 51. Accordingly, should the air blower 12 or 40 generate leakage current, it is discharged to the ground 60 in order to prevent electric shock. Additionally, the first magnetic wave shield 15 or 48 and the second magnetic wave shield 35 or 49 are connected to the ground 60. Therefore, before electromagnetic waves are discharged through the air inlet 21 or 44, electromagnetic waves discharged from the air blower 12 or 40 induce current in the first 15 or 38 and second 35 or 49 electromagnetic wave shields. The induced current is then discharged to the ground 60. Similarly, before the electromagnetic waves are discharged through the air outlet side 31 or 45, electromagnetic waves induce current in the electromagnetic wave shield 38 or 49. The induced current is then discharged to the ground 60.

Accordingly, the air cleaner of the present invention reduces the amount of electrical noise in the external space by bypassing to ground or a grounding component a current induced by electromagnetic waves generated from the operation of an air blower within the air cleaner. Furthermore, leakage current created by the air blower is also bypassed to ground or a grounding component in order to prevent electric shock.

Therefore, the foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification and examples provide a complete description of the manufacture and use of the composition of the invention. Since many embodiments of the invention can be made without departing from the spirit and scope of the invention, the invention resides in the claims hereinafter appended.

What is claimed is:

1. An air cleaner comprising:
an air inlet;
a first electromagnetic wave shield disposed adjacent to the air inlet;
an electrical means for air induction wherein air is drawn through the first electromagnetic wave shield and exhausted towards an air outlet;
a second electromagnetic wave shield disposed adjacent to the air outlet such that exhausted air passes through the wave shield; and
a grounding means for discharging current induced in the first and second electromagnetic wave shields.

2. The air cleaner according to claim 1, wherein the first and second electromagnetic wave shields comprise (10) copper mesh.

3. The air cleaner according to claim 2, wherein the first electromagnetic wave shield further comprises a frame that borders a perimeter of the wave shield.

4. The air cleaner according to claim 2, wherein the second electromagnetic wave shield further comprises means for disposing one or more air filters.

5. The air cleaner according to claim 1, wherein a cabinet comprising electromagnetic wave shielding material houses the air cleaner.

6. The air cleaner according to claim 1, wherein the air cleaner further comprises an ozone discharge tube.

7. The air cleaner according to claim 1, wherein the air cleaner further comprises a negatively charged ion tip.

8. The air cleaner according to claim 1, wherein the grounding means is a grounding component of a ground selection circuit connected to a power source providing an alternating current.

9. The air cleaner according to claim 1, wherein the grounding means is a ground connected to an electrical outlet supplying a current via a plug.

10. The air cleaner according to claim 1, wherein the air cleaner is cylindrical in shape.

11. An air cleaner comprising:
an air inlet;
a first electromagnetic wave shield that comprises 10 copper mesh and a frame, and that is disposed adjacent to the air inlet;
a means for air induction wherein air is drawn through the first electromagnetic wave shield and exhausted towards an air outlet;
a second electromagnetic wave shield that comprises 10 copper mesh and means for disposing one or more air filters, and that is disposed adjacent to the air outlet such that exhausted air passes through the wave shield;
a grounding means for discharging current induced in the first and second electromagnetic wave shields.
a cabinet, comprising electromagnetic wave shielding material, that houses the air cleaner;
a negatively charged ion tip; and
an ozone discharge tube.

12. A method for cleaning air comprising the steps of:
operating an electrical air inducing means to draw in air;
discharging leakage current generated by the operation of the air inducing means to ground;
drawing in air through an air inlet, wherein the air passes through a first electromagnetic wave shield;
shielding the air inlet from electromagnetic waves, which are created by the operation of the electrical air inducing means, with the first electromagnetic wave shield;
discharging electrical current generated in the first electromagnetic wave shield by electromagnetic waves from the electrical air inducing means to ground;
exhausting air through an air outlet, wherein air passes through a second electromagnetic wave shield;
filtering air through one or more filters;
shielding the air outlet from electromagnetic waves, which are created by the operation of the electrical air inducing means, with the second electromagnetic wave shield;
discharging electrical current generated in the second electromagnetic wave shield by electromagnetic waves from the electrical air inducing means to ground; and
exhausting filtered air to an external space.

13. The method of cleaning air according to claim 12, further comprising the step of removing odors from air through the use of an ozone discharge tube prior to exhausting filtered air to an external space.

14. The method of cleaning air according to claim 12, further comprising the step of purifying air through the use of a negatively charged ion tip prior to exhausting filtered air to an external space.
